(19) United States
(12) Patent Application Publication
(10) Pub. No.: US 2016/0095029 A1
(43) Pub. Date: Mar. 31, 2016

(54) METHOD AND APPARATUS FOR FACILITATING IMPROVED ACCESS FOR EFFICIENT CELL CHANGE

(71) Applicant: NOKIA TECHNOLOGIES OY, Espoo (FI)

(72) Inventor: Lars DALSGAARD, Oulu (FI)

(21) Appl. No.: 14/890,467

(22) PCT Filed: May 19, 2014
(86) PCT No.: PCT/FI2014/050377

§ 371 Date: Nov. 11, 2015

Related U.S. Application Data
(60) Provisional application No. 61/825,287, filed on May 20, 2013.

(51) Int. Cl. H04W 36/04; H04W 72/04; H04L 12/26

(52) U.S. Cl. CPC H04W 36/04; H04L 43/062; H04W 72/0413

(57) ABSTRACT

Various methods are provided for facilitating optimized access for efficient offloading in small cell deployments. One example method may comprise causing receiving an indication enabling direct access of one or more cells, causing access to be performed according to the indication of one or more cells that may be accessed, determine an availability of a small cell that fulfills conditions for direct access, changing to small cell if small cell meets conditions, and performing access to small cell if cell is changed and perform access to a macro cell if cell is not changed.

### TECHNOLOGICAL FIELD

Embodiments of the present invention relate generally to a method, apparatus, and computer program product for facilitating improved access for efficient offloading, cell change or mobility in general between two cells in small cell deployments.

### BACKGROUND

Wireless communication is becoming more widespread as a continually increasing number of users acquire and place into operation ever-greater numbers of mobile communication devices. As such, in the future mobile environment, the amount of data that will be transmitted over the air (in wireless systems) will explode. For example, wireless data transmission may increase for example, 1,000 times, as compared to today's load. In order to cope with this increase in data volumes, the use of small cells may be made in a more widely deployed manner (e.g. in HotSpot areas). This deployment may happen on both intra-frequency and inter-frequency compared to a serving macro cell. But in general more dense deployment of small cell may not be as beneficial as co-channel deployment due to interference, while inter-frequency deployment approach may lead to challenges in efficient inter-frequency measurements and mobility for offloading in order to ensure fast, efficient and robust functionality.

### BRIEF SUMMARY

A method, apparatus and computer program product are therefore provided according to an example embodiment of the present invention for facilitating improved access for efficient offloading, cell change or mobility in general between two cells in small cell deployments.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is block diagram of a system that may be specifically configured in accordance with an example embodiment of the present invention;

FIG. 2 is a block diagram of an apparatus that may be specifically configured in accordance with an example embodiment of the present invention;

FIG. 3 is an example flowchart illustrating a method of operating an example apparatus in accordance with an embodiment of the present invention.

FIG. 4 is an example flowchart illustrating a method of operating an example apparatus in accordance with an embodiment of the present invention;

FIG. 5 is an example illustration of a small cell direct access upon user equipment (UE) data transmission initiation in accordance with one embodiment of the present invention;

FIG. 6 is a diagram showing a message sequence chart (MSC) in accordance with one embodiment of the present invention; and

FIG. 7 is block diagram of a system that may be specifically configured in accordance with an example embodiment of the present invention.

### DETAILED DESCRIPTION

Some example embodiments will now be described more fully hereinafter with reference to the accompanying drawings, in which some, but not all embodiments are shown. Indeed, the example embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term “circuitry” refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or application specific integrated circuit for a mobile phone or a similar integrated circuit in a server, a cellular network device, or other network device.

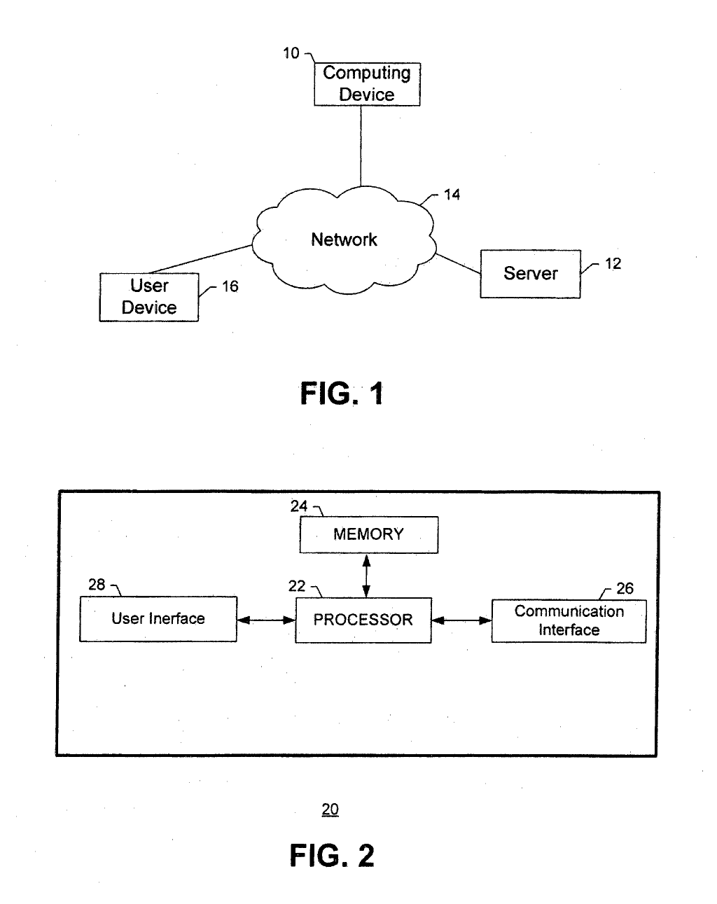

Referring now of FIG. 1, a system that supports communication, either wirelessly or via a wireline, between a computing device 10 and a server 12 or other network entity (hereinafter generically referenced as a “server”) is illustrated. As shown, the computing device and the server may be in communication via a network 14, such as a wide area network, such as a cellular network or the Internet or a local area network. However, the computing device and the server may be in communication in other manners, such as via direct communications between the computing device and the server.

The computing device 10 may be embodied by a number of different devices including mobile computing devices, such as a personal digital assistant (PDA), mobile telephone, smartphone, laptop computer, tablet computer, or any combination of the aforementioned, and other types of voice and text communications systems. Alternatively, the computing device may be a fixed computing device, such as a personal computer, a computer workstation or the like. The server 12 may also be embodied by a computing device and, in one embodiment, is embodied by a web server. Additionally, while the system of FIG. 1 depicts a single server, the server may be comprised of a plurality of servers which may collaborate to support browsing activity conducted by the computing device.

Regardless of the type of device that embodies the computing device 10, the computing device may include or be associated with an apparatus 20 as shown in FIG. 2. In this regard, the apparatus may include or otherwise be in communication with a processor 22, a memory device 24, a communication interface 26 and a user interface 28. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 22 (and/or co-processors or any other processing circuitry assisting or otherwise associated with the processor) may be in communication with the memory device 24 via a bus for passing information among components of the apparatus. The memory device may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus 20 to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 20 may be embodied by a computing device 10 configured to employ an example embodiment of the present invention. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a head mounted display) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor. In one embodiment, the processor may also include user interface circuitry configured to control at least some functions of one or more elements of the user interface 28.

Meanwhile, the communication interface 26 may be any means such as a device or circuitry embodied in either hardware or a combination of hardware and software that is configured to receive and/or transmit data between the computing device 10 and a server 12. In this regard, the communication interface 26 may include, for example, an antenna (or multiple antennas) and supporting hardware and/or software for enabling communications wirelessly. Additionally or alternatively, the communication interface may include the circuitry for interacting with the antenna(s) to cause transmission of signals via the antenna(s) or to handle receipt of signals received via the antenna(s). For example, the communications interface may be configured to communicate wirelessly with the head mounted displays 10, such as via Wi-Fi, Bluetooth or other wireless communications techniques. In some instances, the communication interface may alternatively or also support wired communication. As such, for example, the communication interface may include a communication modem and/or other hardware/software for supporting communication via cable, digital subscriber line (DSL), universal serial bus (USB) or other mechanisms. For example, the communication interface may be configured to communicate via wired communication with other components of the computing device.

The user interface 28 may be in communication with the processor 22, such as the user interface circuitry, to receive an indication of a user input and/or to provide an audible, visual, mechanical, or other output to a user. As such, the user interface may include, for example, a keyboard, a mouse, a joystick, a display, a touch screen display, a microphone, a speaker, and/or other input/output mechanisms. In some embodiments, a display may refer to display on a screen, on a wall, on glasses (e.g., near-eye-display), in the air, etc. The user interface may also be in communication with the memory 24 and/or the communication interface 26, such as via a bus.

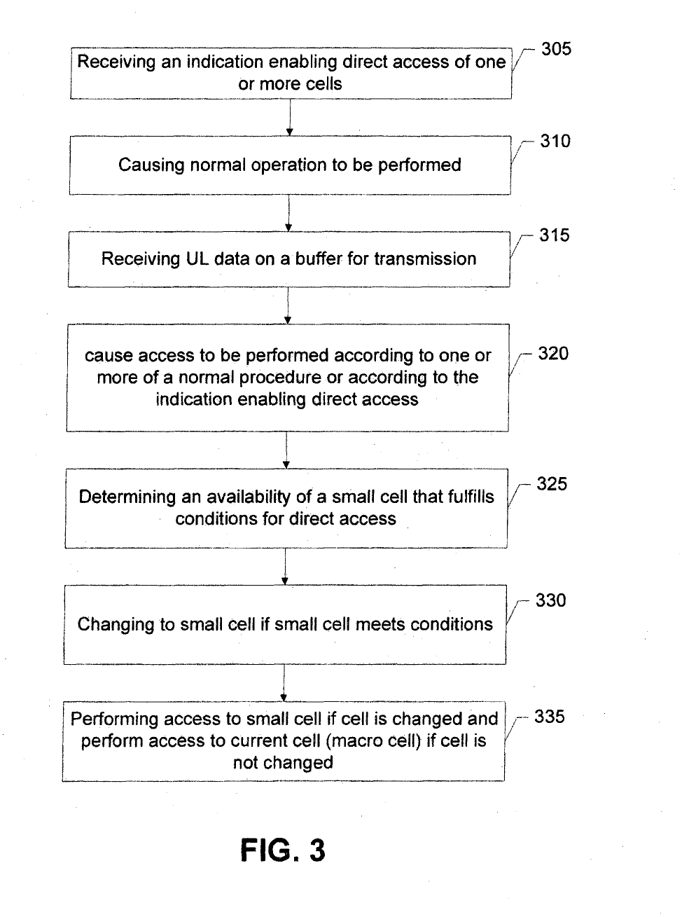

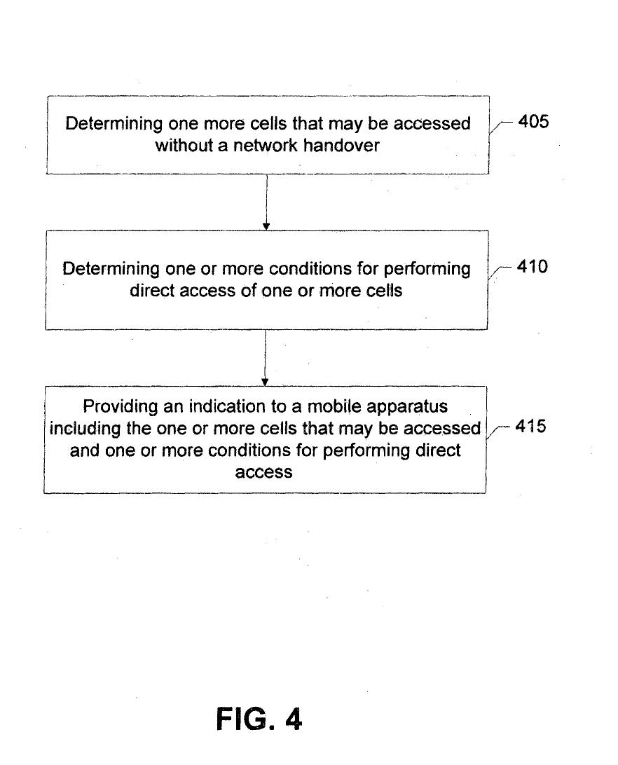

FIGS. 3 and 4 illustrate an example flowchart of the example operations performed by a method, apparatus and computer program product in accordance with an embodiment of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 26 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIGS. 3 and 4, when executed, convert a computer or processing circuitry into a particular machine configured to perform an example embodiment of the present invention. Accordingly, the operations of FIGS. 3 and 4 define an algorithm for configuring a computer or processing to perform an example embodiment. In some cases, a general purpose computer may be provided with an instance of the processor which performs the algorithms of FIGS. 3 and 4 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations herein may be modified or further amplified as described below. Moreover, in some embodiments additional optional operations may also be included. It should be appreciated that each of the modifications, optional additions or amplifications below may be included with the operations above either alone or in combination with any others among the features described herein.

In some example embodiments, a method, apparatus and computer program product may be configured for facilitating optimized, near optimized, or improved access for efficient offloading, cell change or mobility in general between two cells for access. In one embodiment of the present invention, a UE under one or more given conditions may perform access on another cell than a currently camped cell. UE may be allowed to perform access directly on, for example, an offloading cell on another carrier, if the offloading cell RSRP/RSRQ meets a predetermined or predefined threshold.

An example apparatus, e.g., the UE, may be configured by the network to perform cell search and measurements on the carrier on which the small/offloading cells are deployed (e.g. inter-frequency measurements). UE may also be configured to perform the measurements and detect the small cells. In one embodiment, UE may be configured to report the small cells to a network device, although reporting may not be needed. When the UE has detected a cell, e.g. an offloading cell, which fulfills some minimum criteria, e.g. a minimum threshold (Reference symbol received power (RSRP)/reference symbol received quality (RSRQ)) and data arrives in UE buffer (or in general UE has data to be transmitted), the UE may be configured to change cell—e.g. to offloading cell—prior to starting/initiating the access procedure. After the cell change, the UE may be configured to perform access (e.g. on Random Access channel (RACH) or physical uplink control channel (PUCCH)) on the offloading/small cell. If no access is initiated or needed, the UE may not change cell unless, for example, commanded by a network device. In one embodiment, in an example method performed in accordance with the present invention, the UE may perform access directly, without handover, on the offloading cell when such is available and the offloading cell is able, or detected as able, to fulfill the set requirements (e.g. thresholds are fulfilled). As such, the network may not need to command a handover after access on a macro cell. In one embodiment, a method, apparatus or computer program product in accordance with the present invention may be applicable for one of a connected mode UEs or idle mode UEs. However, it would be appreciated by one skilled in the art that the present invention may be applicable to additional states and not limited to the two states or to E-TRAN states.

The present invention is directed to a method, apparatus and computer program product for improved efficient offloading mainly targeted for but not limited to non-carrier aggregation (CA) capable UEs, or in another embodiment, UEs that may not be supporting or configured to support current CA combinations. In yet another embodiment, an example method may be directed to CA capable UE which is not configured with CA. In yet another embodiment, an example method may be directed to for CA capable UEs, e.g., UEs with 2 or more DL as well as potentially 1, 2 or more UL capacity. In the following we will use non-CA case as an example.

In one embodiment, when a UE is operating in a mixed network environment containing both macro and small cells, for example, in which a macro layer capacity in one or more areas may be (capacity) boosted by small cells (e.g. for offloading purposes) on a another carrier or small cell layer, it may be beneficial to keep the UE camped on (i.e. served by) the macro/coverage layer when there is no active data transmission ongoing.

Keeping a UE on macro layer may ensure more robust mobility and may lower the mobility related failures such as for example, handover failures, Radio Link Failures etc. which may keep the network and Key Performance Indicators (KPIs) low. From a network point of view, it may be important to keep the KPIs low. Having deployed small cells for the purpose of offloading the macro cell and increasing the network capacity, it may also be important that when data is then initiated, the UE may be offloaded to offloading cell within a specified period of time (e.g., fast) and with as short delay as possible. Faster offloading may improve or maximize the offloading usage and use of the offloading capacity and may increase the overall system gain from offloading deployment, which may lead to higher system benefits in the form of increased offloading usage, such as improving or maximizing the offloading opportunity.

In some embodiments, keeping the UE on the macro cell may have several benefits. For example, benefits may include benefits related to increased robust mobility for moving UEs, lower signaling etc. Furthermore, optimizing the offloading to small cells also may have benefits in form of efficient usage of deployed offloading cells and possibly higher user throughput due to increased capacity both for UEs offloaded and for other UEs in macro cell (less users/load). Additionally the offloading or small cells may be deployed with efficient DRX for increased UE power saving without negative impact on for example, faster moving UEs, in form of mobility failures (i.e. without negative impact on network KPIs). Additionally, improvements in UE power consumption may be achieved.

In one embodiment, for example, when the UE has data to transmit (e.g. UL data arrives in UE buffer), the UE may initiate access procedure using wither SR or RA burst transmission. Such access procedure may be initiated in UL in the cell in which the UE is currently camped/served. If this approach is kept and the UE is kept on macro/coverage layer, at least two problems may occur: 1) either the offloading efficiency decreases as the UE is not timely handed over to the small cell or 2) there will be an additional delay at each call setup as the UE has to be handed over to the small cell. Alternatively, the network may place the UE on the small cells when they are available which may lead to higher signaling in form of reporting and handover (plus possible network internal impact in form of signaling increase to Core Network (CN)) as well as a possible increase in mobility related errors.

FIG. 3 is an example flowchart illustrating a method for facilitating access for efficient offloading in accordance with an embodiment of the present invention. In one embodiment, the method may enable direct UE access on an offloading cell without the need for a network controlled handover that moves or commands a UE from the macro/coverage cell to the small/offloading cell upon data transmission start/initiation. In one embodiment, an example process may be performed using an Evolved Universal Terrestrial Radio Access (E-UTRA) system. However, it would be appreciated to one skilled in the art, that the operations of FIG. 3 are not limited to cellular systems. For example, non-cellular solutions such as WLAN, may utilize the teachings shown for facilitating improved access for mobility between two or more APs.

As shown in block 305 of FIG. 3, the apparatus 20 embodied by the computing device 10 may therefore be configured to receive an indication enabling direct access. The apparatus embodied by the computing device therefore includes means, such as the processor 22, the communication interface 26 or the like, for receiving an indication enabling direct access.

The network may provide an indication to the UE, (for example, in the measurement configuration) that the UE may perform direct initial access on cells detected on a given configured carrier (or cells) without the need for being handed over to the cell. In one embodiment, the indication may provide that the cells on that carrier may be accessed for initial access prior to or without sending measurement report to network and/or prior to or without explicitly being handed over to such cell. In one embodiment, such an indication may be provided per carrier given (e.g. in measurement configuration). In another embodiment the indication may be provided in a per cell basis by listing cell Physical Cell Identities (PCIs). In another embodiment, the indication may be provided in a combined carrier and list of cell PCI.

As shown in block 310 of FIG. 3, the apparatus 20 embodied by the computing device 10 may be configured to cause normal operation. The apparatus embodied by the computing device therefore includes means, such as the processor 22, the communication interface 26 or the like, for causing normal operation.

As shown in block 315 of FIG. 3, the apparatus 20 embodied by the computing device 10 may be configured to receiving uplink (UL) data in a buffer for transmission. The apparatus embodied by the computing device therefore includes means, such as the processor 22, the communication interface 26 or the like, for receiving an UL transmission on a buffer.

In some embodiment, as shown in block 320 of FIG. 3, the apparatus 20 embodied by the computing device 10 may be configured to cause access to be performed according to one or more of a normal procedure or according to the indication enabling direct access. The apparatus embodied by the computing device therefore includes means, such as the processor 22, the communication interface 26 or the like, for causing access to be performed according to one or more of a normal procedure or according to the indication enabling direct access.

As shown in block 325 of FIG. 3, the apparatus 20 embodied by the computing device 10 may be configured to determine if one or more small cells that fulfills predefined conditions for direct access. The apparatus embodied by the computing device therefore includes means, such as the processor 22, the communication interface 26 or the like, for determining if one or more small cells that fulfills predefined conditions for direct access.

In case of UE initiated data transmissions, access procedure may not be performed on the macro cell but instead the access may be performed directly on the small cell. The cell access may have to be conditioned (i.e. only done if certain criteria are fulfilled) and may be allowed in case a given event for cells on the indicated carrier is fulfilled and a potentially time to trigger (TTT) has expired (if applied), or if the small cell on that carrier is on ‘cellsTriggeredList’. This behavior may lead to that UE actually changes the cell (from macro cell-> to small cell) prior to initiating access, e.g. a random access channel (RACH)/scheduling request (SR) may be performed on small cell and not on the macro cell on the macro/coverage layer (which would most likely be followed by handover). Potentially also reference symbol received quality (RSRQ) of the small cell could be used as an trigger for when the direct may be performed by the UE as the RSRQ (narrow or wideband) would give an indication to the UE about the load condition in the cell prior to initiating access. If RSRQ is too bad the direct access would then not be performed. Also a combination of RSRQ and reference symbol received power (RSRP) could be used.

In some embodiments, the operations shown in step 320, namely determination of one or more specific type of operating states and/or performance thereof, may not be performed prior to step 325. In some embodiments, the operations in step 325 may be performed and the operations of step 320 may not performed. In some embodiments, a UE will determine upon when access is needed, whether direct access is to be performed, such as in step 325, or normal procedure (i.e. normal access to serving cell), such as in step 320, should be performed. As would be appreciated by one skilled in the art, the operations herewith are not restricted to the order given, and the invention is not limited to the embodiments shown. Different combinations of functions as well as an alternative order may be utilized in some embodiments

Referring back to FIG. 3, as shown in block 330 of FIG. 3, the apparatus 20 embodied by the computing device 10 may be configured to change an access cell to a small cell that meets the predefined conditions. The apparatus embodied by the computing device therefore includes means, such as the processor 22, the communication interface 26 or the like, for changing an access cell to a small cell that meets the predefined conditions. In one embodiment, when an RSRP of the small cells does meet a predefined threshold and/or the RSRQ does meet a predefined threshold (i.e. better than serving or better than threshold), the UE is allowed to perform direct access on the cell. In another embodiment, if RSRP meets a predefined threshold but RSRQ indicates high load/interference, the UE may not perform direct access.

As shown in block 335 of FIG. 3, the apparatus 20 embodied by the computing device 10 may be configured to cause access to the small cell if the access cell has been changed or to the current cell if the access cell has not been changed. The apparatus embodied by the computing device therefore includes means, such as the processor 22, the communication interface 26 or the like, for causing access to the small cell if the access cell has been changed or to the current cell if the access cell has not been changed.

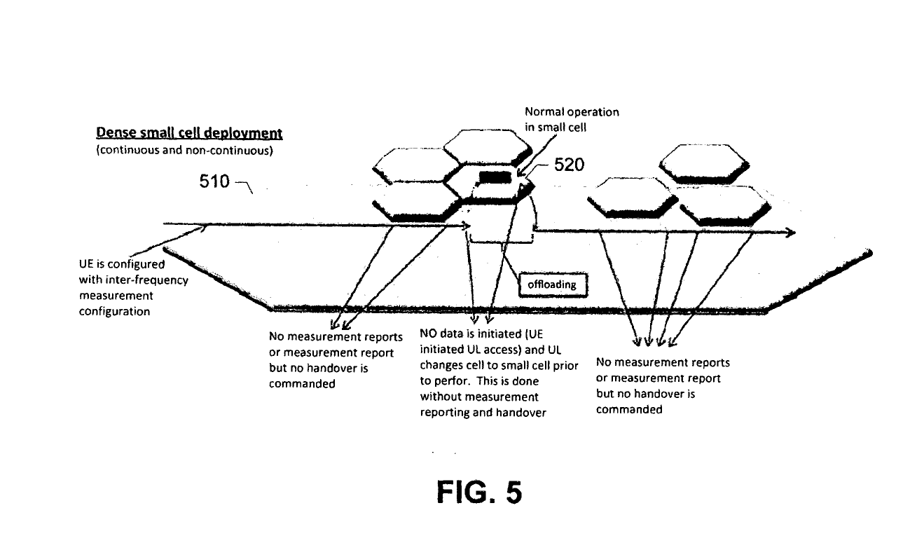

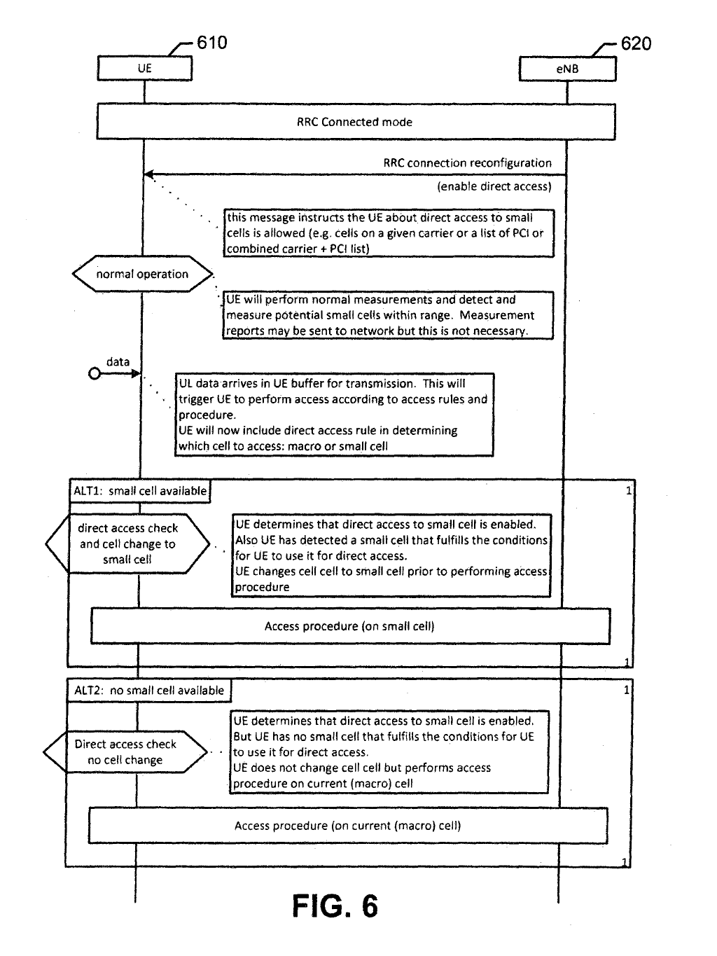

FIGS. 5 and 6 show example embodiments of the present invention. FIG. 5 is an illustration of a small cell direct access upon UE data transmission initiation. FIG. 6 is a diagram showing a message sequence chart (MSC) in accordance with one embodiment of the present invention. Macro cell 510 is used for coverage and UE is kept on the macro layer when there is no active data transmission. Small cells 520 are here deployed for offloading purpose in order to boost the network capacity e.g. in HotSpot areas. When the data transmission is to be initiated, the UE 610 may then evaluate whether direct access can be performed directly on a small cell 520, i.e. the UE 610 may need to be configured to perform this procedure. If the UE 610, based on the configuration and evaluation (based on UE measurements and evaluation), determines that direct access on the small cell 520 is allowed, the UE 610 may then change to the small cell 520 prior to initiating access procedure. When cell has changed, the UE 610 may perform the access procedure. If direct access on the small cell 520 is evaluated as not being possible, the UE 610 may instead perform access on the current macro cell 510.

FIG. 4 is an example flowchart illustrating a method for use in a network device, such as an eNB, in accordance with an embodiment of the present invention. As shown in block 402 of FIG. 4, the apparatus 20 embodied by the computing device 10 may therefore be configured to determine one or more cells that may be accessed by a UE without having to be handed over to the cell. The apparatus embodied by the computing device therefore includes means, such as the processor 22, the communication interface 26 or the like, for determining one or more cells that may be accessed by a UE without having to be handed over to the cell.

As shown in block 405 of FIG. 4, the apparatus 20 embodied by the computing device 10 may therefore be configured to determine one more cells that may be accessed without a network handover. The apparatus embodied by the computing device therefore includes means, such as the processor 22, the communication interface 26 or the like, for determining one more cells that may be accessed without a network handover.

As shown in block 410 of FIG. 4, the apparatus 20 embodied by the computing device 10 may therefore be configured to determine one or more conditions for performing direct access of one or more cells. The apparatus embodied by the computing device therefore includes means, such as the processor 22, the communication interface 26 or the like, for determining one or more conditions for performing direct access of one or more cells.

As shown in block 415 of FIG. 4, the apparatus 20 embodied by the computing device 10 may therefore be configured to provide an indication to a mobile apparatus including the one or more cells that may be accessed and, in some embodiments, one or more conditions for performing direct access. The apparatus embodied by the computing device therefore includes means, such as the processor 22, the communication interface 26 or the like, for providing an indication to a mobile apparatus including the one or more cells that may be accessed and, in some embodiments, one or more conditions for performing direct access.

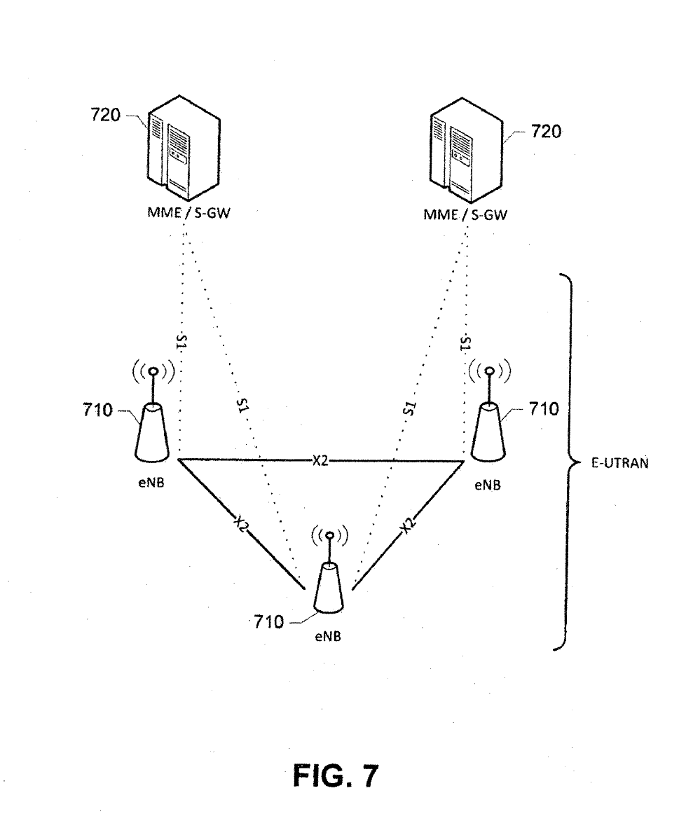

FIG. 7 shows an example illustration of a E-UTRAN architecture that may be used in accordance with one embodiment of the present invention. The E-UTRAN consists of one or more eNBs 710, providing the E-UTRA user plane (PDCP/RLC/MAC/PHY) and control plane (RRC) protocol terminations towards the UE. The eNBs 710 may be interconnected with each other by means of the X2 interface. The eNBs 710 may also be connected by means of the S1 interface to the Evolved Packet Core (EPC), more specifically to the Mobility Management Entity (MME) 720 by means of the S1-MME interface and to the Serving Gateway (S-GW) by means of the S1-U interface. The S1 interface may support a many-to-many relation between MMEs/Serving Gateways 720 and eNBs 710.

In one embodiment, a method is provided for use in a UE, the method comprising causing receiving an indication enabling direct access of one or more cells, causing access to be performed according to the indication of one or more cells that may be accessed, determine an availability of a small cell that fulfills conditions for direct access, changing to small cell if small cell meets conditions, and performing access to small cell if cell is changed and perform access to a macro cell if cell is not changed.

In another embodiment a method is provided comprising determining one more cells that may be accessed without a network handover, determining one or more conditions for performing direct access of one or more cells, and providing an indication to a mobile apparatus including the one or more cells that may be accessed and one or more conditions for performing direct access.

In another embodiment, an apparatus is provided comprising at least a processor, and a memory associated with the processor having computer coded instructions therein, with the computer instructions configured to, when executed by the processor, cause the apparatus to receive an indication enabling direct access of one or more cells, cause access to be performed according to the indication of one or more cells that may be accessed, determine an availability of a small cell that fulfills conditions for direct access, changing to small cell if small cell meets conditions, and perform access to small cell if cell is changed and perform access to a macro cell if cell is not changed.

In another embodiment, an apparatus is provided comprising at least a processor, and a memory associated with the processor having computer coded instructions therein, with the computer instructions configured to, when executed by the processor, cause the apparatus to determine one more cells that may be accessed without a network handover, determine one or more conditions for performing direct access of one or more cells, and provide an indication to a mobile apparatus including the one or more cells that may be accessed and one or more conditions for performing direct access.

In another embodiment, a computer program product is provided comprising a non-transitory computer readable medium having computer program instructions stored therein, said instructions when executed by a processor causing a mobile terminal to receive an indication enabling direct access of one or more cells, cause access to be performed according to the indication of one or more cells that may be accessed, determine an availability of a small cell that fulfills conditions for direct access, change to small cell if small cell meets conditions, and perform access to small cell if cell is changed and perform access to a macro cell if cell is not changed.

In another embodiment, a computer program product is provided comprising a non-transitory computer readable medium having computer program instructions stored therein, said instructions when executed by a processor causing a mobile terminal to determine one more cells that may be accessed without a network handover, determine one or more conditions for performing direct access of one or more cells, and provide an indication to a mobile apparatus including the one or more cells that may be accessed and one or more conditions for performing direct access.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-22. (canceled)

23. A method comprising:
receiving by a user equipment served by a first cell, an indication enabling direct access of one or more second cells;
subsequently receiving an indication of uplink data in a buffer; and
in response to reception of the uplink data, causing direct access of one or more second cells according to the indication enabling the direct access.

24. The method according to claim 23, wherein the indication enabling direct access of one or more second cells comprises one or more conditions.

25. The method according to claim 24, further comprising:
determining an availability of one or more second cells for direct access that fulfill the one or more conditions.

26. The method according to claim 25, further comprising: in an instance in which the availability of at least one second cell is determined, causing access to the at least one second cell to be performed.

27. The method according to claim 25, further comprising: in an instance in which no availability is determined, causing access to a first cell to be performed.

28. The method according to claim 23, further comprising causing direct access of one or more second cells according to the indication prior to or without sending a measurement report or prior to or without being handed over to the one or more second cells.

29. An apparatus comprising at least one processor and at least one memory storing computer program code, wherein the at least one memory and stored computer program code are configured, with the at least one processor, to cause the apparatus to at least:
determine one more second cells that may be accessed without a network handover;
determine one or more conditions for performing direct access of the one or more second cells; and
provide an indication to a mobile apparatus served by a first cell, the indication comprising the one or more second cells that may be accessed and one or more conditions for performing the direct access.

30. The apparatus according to claim 29, wherein the indication is provided in measurement configuration.

31. The apparatus according to claim 29, wherein the indication is provided on a per cell basis.

32. An apparatus comprising at least one processor and at least one memory storing computer program code, wherein the at least one memory and stored computer program code are configured, with the at least one processor, to cause the apparatus to at least:
receive by a user equipment served by a first cell, an indication enabling direct access of one or more second cells;
subsequently receive an indication of uplink data in a buffer; and
in response to reception of the uplink data, cause direct access of one or more second cells according to the indication enabling the direct access.

33. The apparatus according to claim 32, wherein the indication enabling direct access of one or more second cells comprises one or more conditions.

34. An apparatus according to claim 32 wherein the at least one memory and the computer program code are configured to, with the at least one processor, cause the apparatus to determine an availability of one or more second cells for direct access that fulfill the one or more conditions

35. An apparatus according to claim 32 wherein the at least one memory and the computer program code are configured to, with the at least one processor, cause the apparatus to direct access the at least one second cell, in an instance in which the availability of at least one second cell is determined.

36. An apparatus according to claim 32 wherein the at least one memory and the computer program code are configured to, with the at least one processor, cause the apparatus to direct access to a first cell, in an instance in which no availability is determined.

37. An apparatus according to claim 32 wherein the at least one memory and the computer program code are configured to, with the at least one processor, cause the apparatus to direct access of one or more second cells according to the indication enabling the direct access prior to or without sending a measurement report or prior to or without being handed over to the one or more second cells.
